(19) United States
(12) Patent Application Publication
(10) Pub. No.: US 2006/0019164 A1
(43) Pub. Date: Jan. 26, 2006

(54) Lithium storage cell capable of operating at high temperature

(75) Inventors: Frederic Bonhomme, Le Bouscat (FR); Philippe Biensan, Carignan De Bordeaux (FR); David Germond, Le Bouscat (FR); Jean-Marc Laluque, Bordeaux (FR)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/153,324

(22) Filed: Jun. 16, 2005

(30) Foreign Application Priority Data
Jul. 23, 2004 (FR) 0408183

(51) Int. Cl. H01M 4/50; H01M 4/52; H01M 4/58; H01M 4/48

(52) U.S. Cl. 429/223; 429/231.1; 429/231.3; 429/224; 429/231.5; 429/231.4; 429/199

(57) ABSTRACT

The use of a rechargeable lithium storage cell at a temperature lying in the range 80° C. to 180° C., said cell comprising a cathode, an anode comprising either Li₄Ti₅O₁₂ or a carbon-containing material capable of inserting lithium, a separator, a non-aqueous solvent, and a lithium slat, wherein: the active material of said cathode is a lithiated metal oxide having the following formula:
LiNi_{1-x-y}CoₓAl/Mn_{y}O₂ in which: Al/Mn means Al and/or Mn; 0≦x≦0.5; 0≦y≦0.5; the sum x+y being less than 0.66;
and wherein the lithium salt is selected from the group consisting of: LiPF₆, LiBF₄, LiBOB, LiBETI, and mixtures thereof.

### FIELD OF THE INVENTION

The invention relates to a rechargeable lithium battery suitable for operating at very high temperature (in the range 60° C. to 180° C.) whether for storage purposes or while cycling.

### STATE OF THE ART

Present lithium storage cells possess in conventional manner a carbon anode capable of reversibly inserting lithium, a cathode comprising a lithiated oxide of transition metals (LiNiO₂, LiCoO₂, LiMnO₂, LiMn₂O₄, etc.), an electrolyte constituted by a lithium salt dissolved in an organic solvent, and a separator (generally made of polymer).

Such cells are unsuitable for operating at temperatures greater than 60° C. At such temperatures, the rapid deterioration of the active components leads to losses of capacity and to an increase in the internal resistance of the cell, thereby considerably reducing its lifetime.

Lithium storage cells are therefore being sought that present improved lifetimes.

Document EP-A-0 548 449 describes a storage cell with a non-aqueous electrolyte presenting improved lifetime during high-temperature storage (60° C.) by using a solvent made up of a mixture of three ingredients: an aliphatic carboxylate, a cyclic carbonate, and a linear carbonate.

Document EP-A-0 766 332 describes a storage cell having a non-aqueous electrolyte presenting improved lifetime during storage at 80° C. and cycling at 45° C. by using a solvent constituted by a mixture of cyclic carbonate and cyclic ester, a linear carbonate, and a linear ester.

Document U.S. Pat. No. 5,284,722 describes a storage cell having a non-aqueous electrolyte, presenting an improved lifetime in storage while charged at 60° C. and during cycling at 45° C. by using a solvent made up of a mixture of propylene carbonate with an ester.

Those three documents relate essentially to modifications in the formulation of the electrolyte.

Document WO-A-02/09215 describes a lithium-ion storage cell capable of operating at a temperature lying in the range 60° C. to 250° C. The anode active material is constituted by Li₄Ti₅O₁₂. The cathode active material is metallic lithium. The drawback of such a cell is that it delivers an operating voltage of 1.4 volts (V), which is smaller than the 3.7 V operating voltage delivered by a storage cell having its anode made of carbon. Furthermore, in its examples, that document teaches only the Li₄Ti₅O₁₂/Li couple.

A communication of the University of Delft entitled “Development for a high-temperature Li-ion battery” (HITEN 2001, Oslo, Jun. 5-8, 2001) describes an anode active material constituted by Li₄Ti₅O₁₂ and a cathode active material constituted by LiMn₂O₄. That cathode active material decomposes at a temperature that is relatively low. The voltage delivered is 2.7 V.

None of the documents cited teaches nor describes the storage cell of the invention.

### SUMMARY OF THE INVENTION

The invention thus provides a rechargeable lithium storage cell comprising a cathode, an anode comprising either Li₄Ti₅O₁₂ or a carbon-containing material capable of inserting lithium, a separator, a non-aqueous solvent, and a lithium salt, wherein the active material of said cathode is a lithiated metal oxide and wherein the lithium salt is selected from the group constituted by LiPF₆, LiBF₄, LiBOB, LiBETI, and mixtures thereof.

The storage cell of the invention is adapted to operate at temperatures of up to 180° C.

The invention also provides the use of a storage cell of the invention at a temperature of up to 180° C.

### BRIEF DESCRIPTION OF THE FIGURES

FIG. 1 shows variation in the capacity discharged by cells of series A, B, and C of the invention as a function of the number of cycles performed, during cycling tests constituted by five cycles at 100° C., ten cycles at 120° C., and five cycles at 150° C.

FIG. 2 shows variation in the internal impedance of accumulators in the cells A, B, and C of the invention as a function of the number of cycles performed, during cycling tests constituted by five cycles at 100° C., ten cycles at 120° C., and five cycles at 150° C.

FIG. 3 shows variation in the capacity discharged by cells of series B, D, and E of the invention as a function of the number of cycles performed, during cycling testing at 120° C.

### DETAILED DESCRIPTION OF EMBODIMENTS OF THE INVENTION

In conventional manner, the storage cell comprises a positive electrode (cathode), a negative electrode (anode), a separator between them, and an electrolyte.

The cathode is one of the portions that characterize the storage cell of the invention. It is known that LiNiO₂ as such does not present good high-temperature stability. At high temperature, LiNiO₂ is less stable than other cathode materials such as LiCoO₂. Surprisingly, in the storage cell of the invention, this material behaves differently. The invention proposes a cathode material based on LiNiO₂ and preferably obtained by substituting a fraction of the nickel in LiNiO₂ with cobalt and/or aluminum or manganese. The active material as produced in this way presents good high-temperature stability and good capacity once in the storage cell.

In general, the positive electrode comprises an electrochemically active material which is mainly a lithiated metal oxide having the following formula:
LiNi_{1-x-y}CoₓAl/Mn_{y}O₂
in which:

Al/Mn means Al and/or Mn;

0≦x≦0.5 and preferably 0.15<x<0.33; and

0≦y≦0.5 and preferably 0.05<y<0.33;

with the sum x+y being less than 0.66 (1-x-y>0.33).

The active material of said cathode is generally a lithiated metal oxide of lamellar structure of the R-3m type.

In an embodiment, the sum x+y is less than 0.5.

In an embodiment, the active material of the cathode comprises cobalt and aluminum or manganese.

The following compounds are preferred: LiNi_{0.8}Co_{0.15}Al_{0.05}O₂ and LiNi_{0.55}Co_{0.15}Mn_{0.30}O₂.

The positive electrode also includes a binder such as polyvinylidene fluoride (PVDF) or a mixture of carboxymethylcellulose (CMC) and sytrene-butadiene polymer (SBR) for increasing the mechanical strength and the flexibility of the electrode. It also generally includes particles of carbon in order to improve the electrical conductivity of the electrode.

The negative electrode is constituted mainly either by Li₄Ti₅O₁₂, or by a carbon-containing material capable of reversibly inserting lithium, such as graphite, coke, carbon black, vitreous carbon, and mixtures thereof. It also includes a binder such as polyvinylidene fluoride (PVDF) or a mixture of carboxymethylcellulose (CMC) and sytrene-butadiene polymer (SBR).

The separator is generally a polymer possessing a high melting temperature, typically greater than 150° C., such as polypropylene (PP), polytetrafluoroethylene (PTFE), polyacrylonitrile (PAN), or polyethylene-terephthalate (PET) with its surface optionally coated in ceramic, and mixtures thereof. It is preferable to use polypropylene or PET with or without ceramic, and more preferably coated in ceramic. The electrolyte is an organic solvent selected from the group of cyclic carbonates, such as propylene carbonate (PC) and ethylene carbonate (EC), and from lactones (such as gamma-butyrolactone) that are thermally stable, and from mixtures thereof. It is preferable to select an equimolar PC/EC mixture having 2% vinylene carbonate (VC) added thereto, as described in patent application EP-A-0 683 537. A particular effect of vinylene carbonate is to stabilize the passivation layer formed on the carbon electrode. In general, the solvent is such that it has a boiling point of not less than 150° C., and preferably not less than 200° C.

The salt used is a lithium salt selected from the following salts: LiPF₆, LiBF₄, LiBOB (lithium bis oxalatoborate), LiBETI (lithium bisperfluoroethylsulfonylimide), and mixtures thereof. LiPF₆ is preferred. Once again, these salts are not highly temperature stable, and in particular LiPF₆ decomposes from 80° C. in application of the following reaction:
LiPF₆→LiF+PF₅

Surprisingly, this salt, when in a storage cell of the invention, is particularly stable. The concentration of salt in the solvent is variable, e.g. in the range 0.5 molar to 1.5 molar in the solvent.

Cells have been produced in conventional manner. The electrodes were prepared by coating an ink on a metal foil, the ink being constituted by a mixture of active material, a percolating agent (e.g. carbon), and a binder dispersed in a solvent. Once coated, the electrodes were dried to allow the solvent to evaporate. The foils were made of carbon or of metal, such as copper, nickel, stainless steel, or aluminum, for example. The positive electrode, the separator, and the negative electrode were superposed. The assembly was then rolled up to form the electrochemical stack. A connection part was bonded to the edge of the positive electrode and connected to the current output terminal. The negative electrode was electrically connected to the can of the cell. Depending on the format of the cell, the positive electrode could be connected to the can and the negative electrode to an output terminal. After being inserted into the can, the electrochemical stack was impregnated in electrolyte. Thereafter the cell was closed in leaktight manner. The can was also provided in conventional manner with a safety valve (capsule) causing the cell to open in the event of the internal gas pressure exceeding a predetermined value.

The invention presents advantages other than that of extending the lifetime of the cell and enabling it to operate at high temperature. By lowering the quantity of gas generated at high temperature, the risk of the can bursting open and the gas catching fire is limited, thereby providing the user with improved safety.

The temperature at which the cell of the invention can be used may lie in the range −40° C. to +180° C., and in particular in the range 20° C. to 150° C. The cell of the invention can be used in all of the conventional fields, such as roaming or stationary equipment.

The present invention relates to lithium storage cells of prismatic shape (plane electrodes) or of cylindrical shape (spiral-wound electrodes), or of concentric shape.

### EXAMPLES

The following examples illustrate the invention without limiting it.

Five series of two lithium ion cells of ⅘A format were prepared.

The first series of cells, written A, was constituted as follows:

The positive electrode was constituted by the following, in % by weight:

| | |
|---|---|
| LiCoO₂ | 93% |
| divided carbon | 2% |
| PVDF binder | 5% |

The negative electrode was constituted by the following, in % by weight:

| | |
|---|---|
| graphite | 96% |
| cellulose (CMC) | 2% |
| SBR | 2% |

The electrolyte was constituted by 98% by weight of a 50/50 mixture of propylene carbonate and ethylene carbonate (PC/EC) together with 2% by weight of vinylene carbonate (VC).

The salt dissolved in the electrolyte was molar lithium hexafluorophosphate LiPF₆.

The separator was a microporous membrane of polypropylene.

The second series of cells, written B, differed from the first series A solely by the fact that the positive active material was replaced by a substituted phase of LiNiO₂, in particular LiNi_{0.8}Co_{0.15}Al_{0.05}O₂.

The third series of cells, written C, differed from the second series B solely by the fact that the polypropylene separator was replaced by a PTFE separator.

The fourth series of cells, written D, differed from series A, by having a cathode constituted by LiNi_{0.55}Co_{0.15}Mn_{0.30}O₂ and by a polyethylene-terephthalate (PET) separator coated in ceramic.

The fifth series of cells, written E, differed from series B by having a separator of polyethylene-terephthalate (PET) coated in ceramic.

Table 1 summarizes the characteristics of the cells as assembled:

TABLE 1

| Series | Cathode active material | Separator |
|---|---|---|
| A | LiCoO₂ | PP |
| B | LiNi_{0.8}Co_{0.15}Al_{0.05}O₂ | PP |
| C | LiNi_{0.8}Co_{0.15}Al_{0.05}O₂ | PTFE |
| D | LiNi_{0.55}Co_{0.15}Mn_{0.30}O₂ | PET + ceramic |
| E | LiNi_{0.8}Co_{0.15}Al_{0.05}O₂ | PET + ceramic |

Each type of cell was duplicated for the tests.

The six cells of the series A, B, and C were subjected to the following thermal cycling tests:
five cycles constituted by charging at ambient temperature followed by discharging at a current of 10 milliamps (mA) at 100° C.;
ten cycles constituted by charging at ambient temperature followed by discharging at a current of 10 mA at 120° C.; and
five cycles constituted by charging at ambient temperature followed by discharging at a current of 10 mA at 150° C.

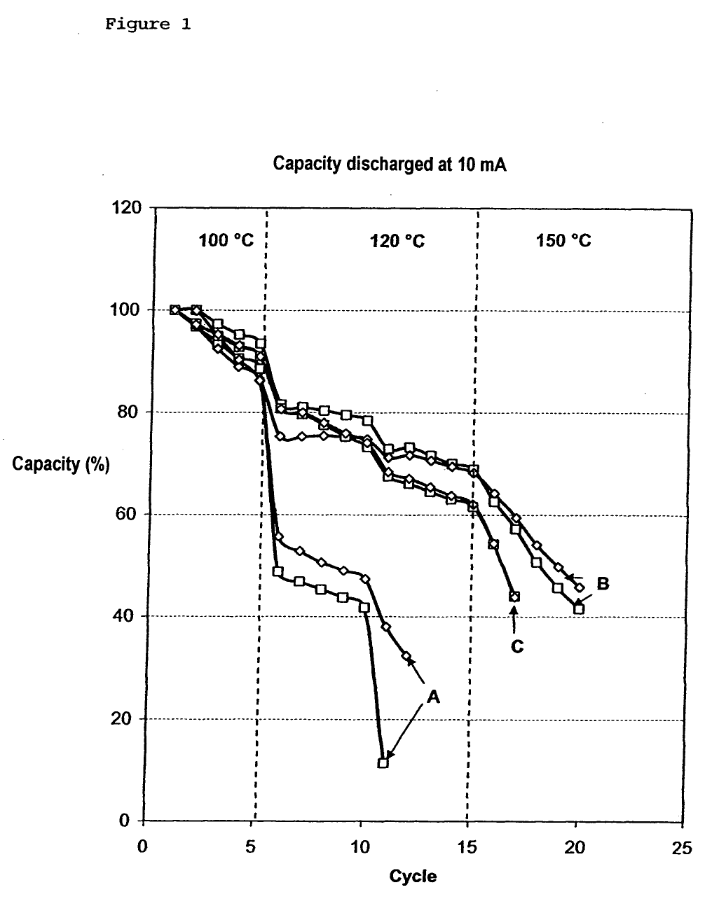

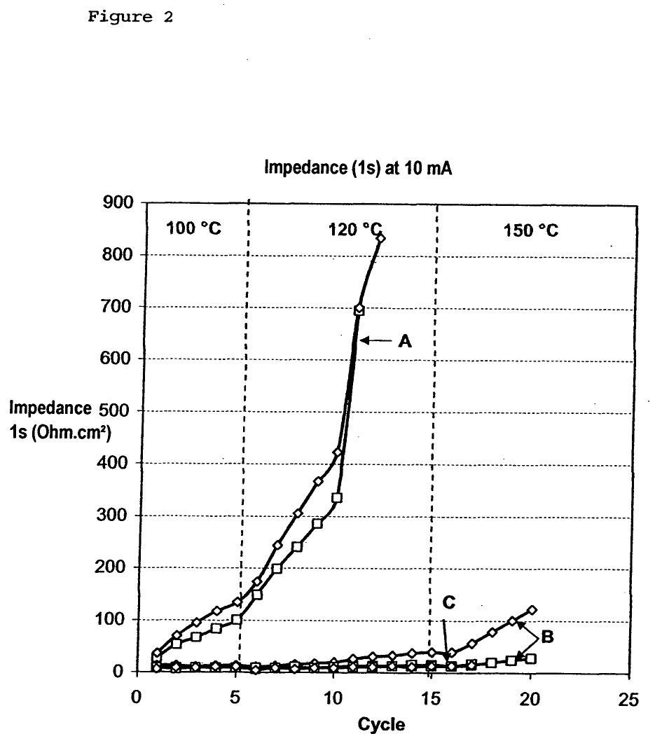

The results of this testing are given in FIGS. 1 and 2 and in Table 2.

The six cells of series B, D, and E were subjected to the following thermal cycling tests:
13 cycles constituted by charging at ambient temperature followed by discharging at a current of C/120 at 120° C.

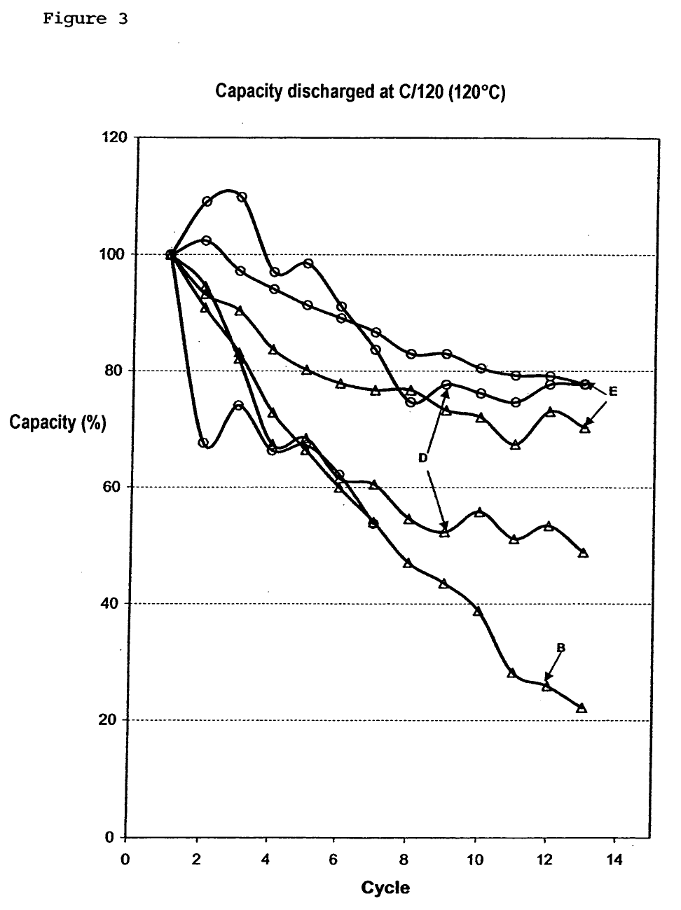

The results of this testing are given in FIG. 3.

TABLE 2

| Series | Element | Total loss of capacity (%) | Remarks |
|---|---|---|---|
| A | A-1 | 88.6 | Short circuit on cycle 11 |
| | A-2 | 67.7 | Short circuit on cycle 12 |
| B | B-1 | 58.5 | — |
| | B-2 | 54.3 | — |
| C | C-1 | 56.0 | Short circuit on cycle 17 |
| | C-2 | 56.2 | Short circuit on cycle 17 |

FIG. 1 shows that:
the cells of the second series present the smallest loss of total capacity;
the cells having the LiCoO₂ cathode in series A failed on cycles 11 and 12, whereas the cells having the substituted LiNiO₂ cathode in series B were still operational on cycle 20; and
the cell having a PP separator in series B were still operational on cycle 20, whereas the cells having a PTFE separator in series C failed in cycle 17.

FIG. 2 also shows that the internal impedance of cells having an LiCoO₂ cathode in series A increased very strongly during cycling when compared with cells having an LiNiO₂ cathode in series B and C.

These tests thus show that cells of the invention are adapted to operating at high temperature, in particular the cells in series B, i.e. those having a substituted LiNiO₂ cathode and provided with a PP separator.

Comparing the curves for series B and E in FIG. 3 shows that the loss of capacity for cells E provided with a ceramic-coated polyethylene-terephthalate (PET) separator is less than the loss of capacity for the cells B provided with a polypropylene separator, the materials of the electrodes and of the electrolytes being identical for both series.

Furthermore, comparing the curves of series D and E shows that the loss of capacity for the cells D provided with cathodes made of LiNi_{0.55}Co_{0.15}Mn_{0.30}O₂ is comparable with the loss of capacity for the cells E provided with a cathode made of LiNi_{0.8}Co_{0.15}Al_{0.05}O₂, the materials of the anode, the separators, and the electrolytes being identical for the two series D and E.

1. The use of a rechargeable lithium storage cell at a temperature lying in the range 80° C. to 180° C. said cell comprising a cathode, an anode comprising either Li₄Ti₅O₁₂ or a carbon-containing material capable of inserting lithium, a separator, a non-aqueous solvent, and a lithium salt, wherein:
the active material of said cathode is a lithiated metal oxide having the following formula:
LiNi_{z-x-y}CoₓAl/Mn_{y}O₂
in which:
Al/Mn means Al and/or Mn;
0≦x≦0.5;
0≦y≦0.5;
the sum x+y being less than 0.66;
and wherein the lithium salt is selected from the group consisting of: LiPF₆, LiBF₄, LiBOB, LiBETI, and mixtures thereof.

2. The use of a cell according to claim 1, in which, in the formula for the lithiated metal oxide:
0.15<x<0.33; and
0.05<y<0.33.

3. The use of a cell according to claim 1, in which the active material of the cathode includes cobalt and aluminum or manganese.

4. The use of a cell according to claim 1, in which the active material of the cathode is selected from the group consisting of LiNi_{0.8}Co_{0.15}Al_{0.05}Oₓ and LiNi_{0.55}Co_{0.15}Mn_{0.30}O₂.

5. The use of a cell according to claim 1, in which the lithium salt is LiPF₆ .

6. The use of a cell according to claim 1, in which the anode comprises a carbon-containing material capable of reversibly inserting lithium.

7. The use of a cell according to claim 6, in which the carbon-containing material of the anode is selected from the group consisting of: graphite, coke, carbon black, vitreous carbon, and mixtures thereof.

8. The use of a cell according to claim 1, in which the non-aqueous solvent is selected from the group consisting of: lactones and cyclic carbonates, such as propylene carbonate and ethylene carbonate.

9. The use of a cell according to claim 8, in which the non-aqueous solvent has a boiling point of not less than 150° C., preferably not less than 200° C.

10. The use of a cell according to claim 1, in which the separator material is selected from the group consisting of: polypropylene, polytetrafluoroethylene, polyacrylonitrile, polyethylene-terephthalate, ceramic-coated polyethylene-terephthalate, and mixtures thereof.

11. The use of a cell according to claim 10, in which the separator material is polypropylene or ceramic-coated PET.

12. The use of a cell according to claim 1, in which said use is performed in storage.

13. The use of a cell according to claim 1, in which the use is performed in cycling.

14. The use of a cell according to claim 13, in which the charging step during cycling is performed at ambient temperature.

15. The use of a cell according to claim 14, in which the utilization temperature of said cell lies in the range 120° C. to 180° C., and preferably in the range of 150° C. to 180° C.

16. An electrochemical storage cell comprising a cathode, an anode comprising either Li₄Ti₅O₁₂ or a carbon-containing material capable of inserting lithium, a separator of ceramic-coated polyethylene-terephalate, a non-aqueous solvent, and a lithium salt, the active material of said cathode being a lithiated metal oxide having the following formula:
LiNi_{1-x-y}CoₓAl/Mn_{y}O₂
in which
Al/Mn means Al and/or Mn;
0≦x≦0.5;
0≦y≦0.5;
the sum x+y being less than 0.66;
and the lithium salt being selected from the group consisting of LiPF₆, LiBF₄, LiBOB, LiBETI, and mixtures thereof.

17. (canceled)
